(19) United States
(12) Patent Application Publication
(10) Pub. No.: US 2005/0144593 A1
(43) Pub. Date: Jun. 30, 2005

(54) Method and system for testing an application framework and associated components

(76) Inventors: Yuvaraj Athur Raghuvir, Bangalore (IN); Henry Marcalino Allwyn, Bangalore (IN); Amit Jain, Bangalore (IN); Abhijit Bora, Bangalore (IN)

Correspondence Address: KENYON & KENYON, ONE BROADWAY, NEW YORK, NY, 10004, US

(21) Appl. No.: 10/749,880

(22) Filed: Dec. 31, 2003

(51) Int. Cl. G06F 9/44

(52) U.S. Cl. 717/124

(57) ABSTRACT

The present invention provides a method and system of testing of an application framework and associated application framework components with respect to framework semantics.

### FIELD OF THE INVENTION

The present invention relates to the areas of software engineering and development. In particular, the present invention provides a method and system for testing software frameworks, components and architectures.

### BACKGROUND INFORMATION

The complexity of modem software architectures present significant challenges for the testing and debugging of developed software applications. A testing system should also allow verification of independent functionalities of a software component. In addition, the architecture should allow for testing multiple combinations of these functionalities. To test a component completely it is imperative to test as many combinations (if semantically valid) as possible. Thus, upon defining functional dimensions and providing functionality that can be exhibited in each dimension, combinations of these functional dimensions must be realized. However, as software structures continue to grow in complexity, testing these functional dimensions becomes computationally complex.

FIG. 1, which is prior art, depicts a software development paradigm. Application framework 215 defines a common architecture for applications 140 by providing services and functionalities that may be consumed by an application 140 running on framework 215. Application framework 215 defines a format, language or semantics for developed applications by providing a set of constructs and relationships between them. Application developer 150 utilizes application design environment 160 to create a software application as a function of application framework 215. FIG. 1 also shows testing module 150 for testing application 140. Testing module provides services and functions to allow application developer 150 to test developed software applications.

FIG. 2 shows the operation of testing module 150 which operates on a unit level. In particular, application 140 includes a plurality of development classes 205(1)-205(N). Testing module 150 associates any of a plurality of development classes 205(1)-205(N) with particular test classes 285(1)-285(N). Testing module then performs testing of application 140 via test classes 285(1)-285(N) and their interaction with corresponding development classes 205(1)-205(N).

Many known methods exist for unit testing of frameworks. Two significant methodologies include Test Application and the JUnit Framework for testing classes. JUnit is a program used to perform unit testing of virtually any software. JUnit testing is accomplished by writing test cases using Java, compiling these test cases and running the resultant classes with a JUnit Test Runner.

Known testing systems and methods for testing software applications such as JUnit and methods operate at the unit level. For example JUnit is oriented to particular Java class. In particular, the paradigm of known test methods is to associate a test class with a development class. Thus, JUnit level testing is fine granular making the mechanism difficult to extend for scenario level testing across different objects. Extensions to JUnit address class level testing. However, extensions to framework API testing based on this concept is not known.

FIG. 3, which is prior art, depicts a testing sequence for JUnit, which is representative of a unit testing methodology. As shown in FIG. 3, the method includes the following steps. In step 205, the process is initiated. In step 210, a TestSuite is defined consisting of test cases. In step 215, each TestCase (“TC”) performs an associated test. In step 220, results of the test are placed in a TestResult instance. In step 225, the TestResult instance consolidates failures and errors. In step 230, a report of the TestSuite is placed at the beginning of a TestReport. The process ends in step 240.

FIG. 4 depicts the object model for JUnit, which is a testing framework for Java Classes and defines a paradigm on which Java classes may be tested. JUnit allows the definition of collaborative classes such as Test, TestCase, TestResult etc. It further provides the use of a Decorator Pattern to achieve flexibility of mixing classes for testing. In addition, JUnit, allows the use of reflexive language features of Java to dynamically discover methods, which can be used for testing.

Referring to FIG. 4, TestCase includes the method TestCase:run(result:TestResult), which is implemented as:

```
public void run (TestResult result) {
    result.startTest(this);
    setUp( );
    try {
        runTest( );
    }
    catch (AssertionFailedError e) {
        result.addFailure (this, e);
    }
    catch (Throwable e) {
        result.addError(this, e);
    }
    tearDown( );
    result.endTest(this);
}
```

The testing sequence for the JUnit paradigm is as follows: (1) a TestSuite 405(1) consists of TestCases 405(2); (2) A TestResult instance 405(3) is passed on to all the TestCases 405(2); (3) Each TestCase 405(2) performs the Test; (4) Results of the Test are placed in the TestResult 405(3); (5) The TestResult 405(3) consolidates the failures and errors; (6) Report of the TestSuite 405(1) is placed at the beginning of the TestReport (not shown).

The unit testing paradigm (e.g., JUnit) imposes significant restrictions and limitations, especially as the testing scenario involves the collaboration of many different classes and/or components. In particular, to realize functionalities exhibited by many collaborating classes, unit testing scales poorly. For example, it is possible to test a class by testing interfaces exposed by the class. However, if there are 3-4 classes collaborating to provide certain functionality, it is not straightforward to create test classes for each.

Furthermore, unit testing is white box testing in that it tests the internals of a class. The duty of tester with known systems is to determine whether all of the combinations of functionalities exposed by the component are valid. However, this scenario is impractical for complex software systems as there involves a combinatorial explosion in a reasonably complex software component. If the tester/developer is required to generate test classes, the testing environment becomes extremely tedious and error prone because one method of a test class must invoke a combination of functionalities. If the number of combination is large, the number of test classes grows proportionally.

In addition, during the development process, a significant challenge exists to provide a mechanism for testing an application framework as well as custom extensions that operate within the framework. For example, developers may define valid points that the framework should reach. Reaching these states thus corresponds to achieving associated intended functionalities. In particular, the valid states define valid operations with respect to the framework. In addition, invalid operations with respect to the framework may defined, which should flag an error.

One paradigm for testing of software applications compares what was intended by a software architect with what was realized by a software developer. For example, the framework defines semantics of states which are valid. Thus, the semantics implemented by framework are the semantics to be intended. It would be desirable to provide a testing framework to operate on this level—namely to determine whether intended semantics as defined by the framework are those implemented by the software component.

In particular, with respect to intended semantics, a software component is typically defined with respect to a certain behavior. The behavior of component relates to its functionalities or operations. The development paradigm then typically has the following structure: The architect designs a software component with a certain behavior. This behavioral information is then provided to the developer to develop a component. The architect desires to know whether the defined behavior corresponds to what the developer implemented. The behaviors designed by architect are the intended ones.

Application frameworks may employ any varied semantic structure. One class of frameworks, for example, utilize a semantics structure defined by the begin and end of an operation as well as specific behavior defined in the begin and end of the operation. Furthermore, there may be many options for the begin and end of any particular operation. Maximal test coverage should ideally test for all possible options to determine the robustness of the framework. Creation of a test application involves exploring as many possibilities through test cases, which can be quite high in even fairly complex frameworks.

It would be desirable to provide a testing methodology that allows for testing of an arbitrary software component at a more abstract level than the unit testing methodology. In particular, it would be desirable to allow testing of a software architecture that operates at the semantic level of a particular framework.

### SUMMARY OF THE INVENTION

The present invention provides a method and system of testing of an application framework and associated application framework components with respect to framework semantics. According to the present invention testing is performed on the granular/structural level of an operation. According to the present invention, an operation includes begin, end and core elements. Each operation may include the collaborative behavior of any number of development classes.

The testing method is achieved by defining a plurality of test case classes, each test case class corresponding to an operation. Defining a relationship between a particular set of test case classes, the relationship corresponding to a particular scenario to be tested. The scenario is then tested to determine whether it is semantically correct with respect to the underlying application framework. According to one embodiment this is achieved by receiving information regarding valid start states and probable end states. Alternatively, this may be achieved by providing an editor which allows only for semantically valid relations to be defined between test case classes.

According to further embodiments of the invention, the scope of testing in a test run can be defined as exploring some of the operations begin/end options or all. Furthermore, the priority of operations may be defined per nesting level. This feature is useful when changes are made in one operation and its corresponding options must be regression tested in the context of a scenario. During the course of the test suite run, the high priority test cases execute first in order to speed error tracking.

The present invention provides a method and system for extending framework testing to framework API testing, extending test coverage of the framework API, validating test suite hierarchies as framework semantic compliant or not and automated testing and verification with suitable adaptation of logging mechanisms.

According to one embodiment, the present invention provides a novel adaptation of the JUnit framework. According to the present invention, a TestCase Class is defined for an operation/finctionality. This class is capable of exploring all possible options for the begin operation and end operation. The TestCase corresponds to an operation, which could involve collaboration of many classes. Alternatively, the TestCase class may be defined per semantic API (“Application Programming Interface”) of the framework.

The TestCase classes may be hierarchically organized to reflect a scenario, which needs to be tested. Such a hierarchical structure is a TestSuite associated to a certain scenario being tested. The hierarchy can be validated to be semantically cored with respect to the framework semantics. In particular, arbitrary nesting is eliminated and only semantically valid nesting is accepted. This is achieved via two possible mechanisms. According to one embodiment, the TestCase framework can define states for each of the TestCase classes and define what are the valid start states for the test case and the probable end states. Based on this information, the hierarchy of test cases constructed can be validated. According to an alternative embodiment, the TestCase construction can be done using an editor, which allows only for valid nesting of test cases.

According to one embodiment of the present invention, the scope of testing in a test run can be defined as exploring some or all of the begin/end options. In addition, according to one embodiment, the priority of operations can be defined per nesting level. This feature may be helpful when changes are made in one operation and all of the associated options for that level must be regression tested in the context of a scenario. During the course of the test suite run, the high priority test cases execute first in order to improve the speed of error tracking.

According to one embodiment, logging may be defined depending upon framework invariants and variants. By adding suitable support mechanisms, testing can be automated with results verification as simple as finding differences in an output log file compared with a validated output log file.

The present invention allows a developer to create a test framework that allows focus on functionality and then workflow. According to one embodiment, the dimensions of a software component are identified. Then, the variations in each of these dimensions is identified. Next, a representative class called the test case class, is generated. The test case class operates as a placeholder for functionality of the software component and exposes or is aware of all the variations of the functional dimensions. The test case classes can then be combined to create semantic control flow like a tree.

For example, certain dependencies across the different nodes like a tree may be tested. There may be data exchange across nodes, which then becomes a graph. According to this example, a test case graph may be assembled, which when executed at runtime will explore a certain combination defined for a particular control flow. A developer would like to define a flow of control that would test the change or enhancement he has created. During quality management it is necessary to test not only semantically valid control flows but also to check all combinations so that the software doesn't get into certain state which causes error. Invalid semantic flows should show an error. Thus, functionality as intended as well as functionality as unintended (i.e., if unintended should throw an error) is tested. This increases the sample space for testing.

### BRIEF DESCRIPTION OF THE DRAWINGS

FIG. 1, which is prior art, depicts a software development paradigm.

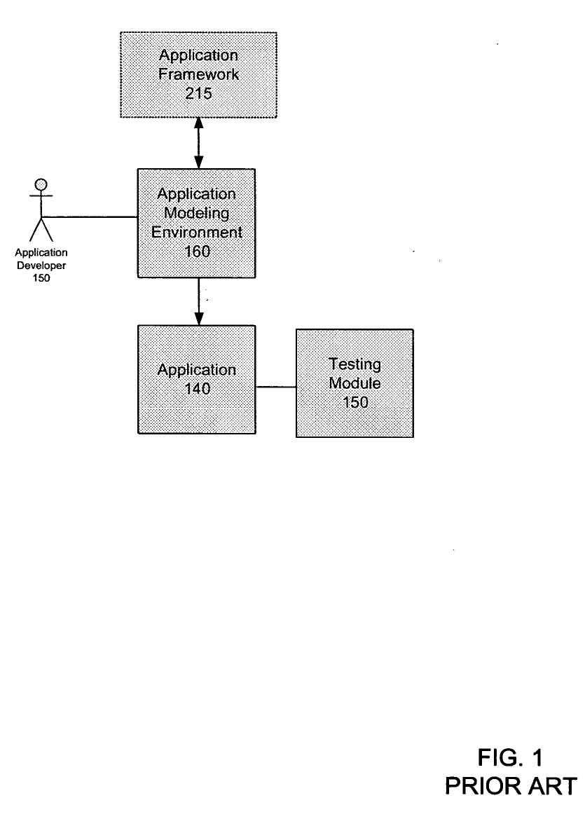

FIG. 2, which is prior art, shows the operation of testing module which operates on a unit level.

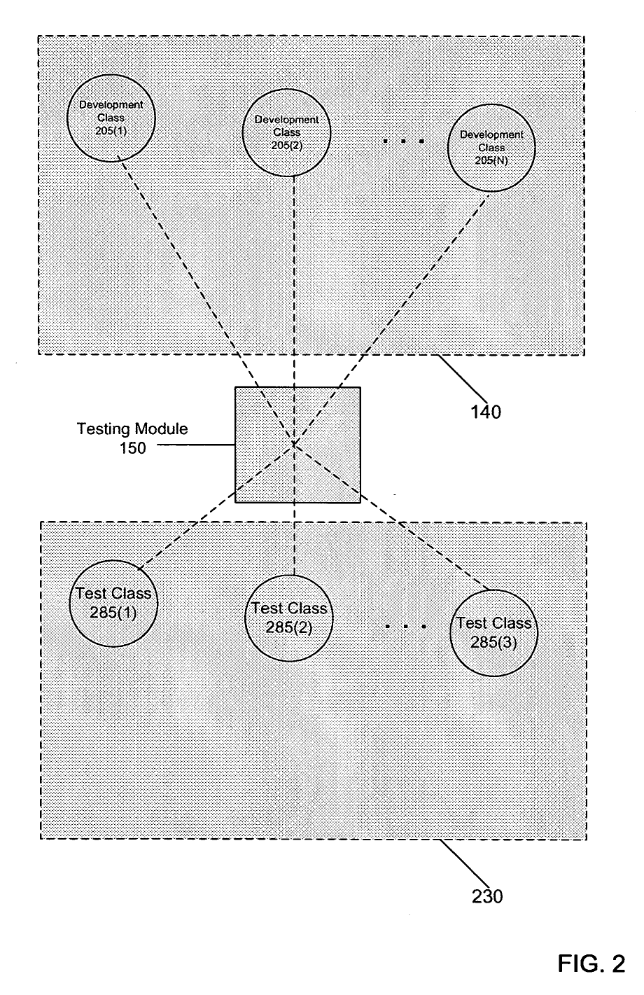

FIG. 3, which is prior art, depicts a testing sequence for Junit, which is representative of a unit testing methodology.

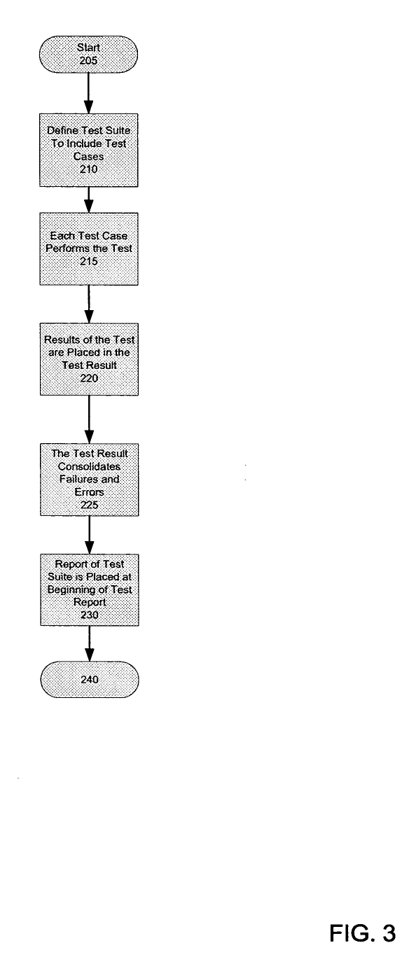

FIG. 4, which is prior art, depicts an object model for Junit, which is a testing framework for Java Classes and defines a paradigm on which Java classes may be tested.

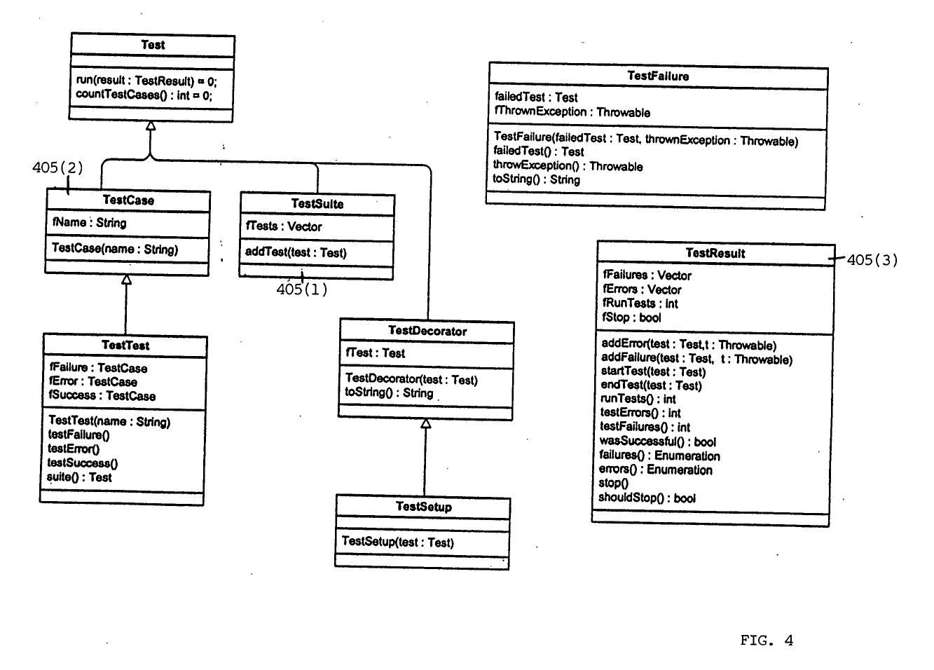

FIG. 5 depicts the structure of an operation according to one embodiment of the present invention.

FIG. 6 shows the structure of a test suite according to one embodiment of the present invention.

FIG. 7 depicts an operation of a testing module according to one embodiment of the present invention.

FIG. 8 is a flowchart depicting the operation of a testing module according to one embodiment of the present invention.

FIG. 9 depicts a test framework object model according to one embodiment of the present invention.

FIG. 10 is a flowchart depicting basic control flow of the testing module according to one embodiment of the present invention.

FIG. 11 depicts a structure of a test framework object model according to one embodiment of the present invention.

### DETAILED DESCRIPTION

The present invention provides a testing framework that operates at the level of operations rather than the unit level. In order to achieve this, according to one embodiment, a test case class is defined for each operation. Thus, by definition, the test case corresponds to an operation that may involve the collaboration of many classes. The test case classes may be hierarchically organized to reflect a scenario, which needs to be tested. Such a hierarchy is referred to herein as a test suite. The hierarchy can be validated to be semantically correct with respect to the framework semantics, i.e., arbitrary nesting is eliminated in favor of only accepting semantically valid nestings. In order to achieve this semantic validation, two embodiments are provided. According to a first embodiment, the test case framework defines states for each of the test case classes to define the valid start states and the probable end states. Based on this information, the hierarchy of test cases constructed can be validated. According to an alternative embodiment, the test case construction may be accomplished with an editor that allows only the valid nesting of test cases.

According to the present invention, the scope of testing in a test run can be defined as exploring some or all of the operations begin/end options. The priority of operations can be defined per nesting level. This is helpful when changes are made in one operation and all of its options have to be regression tested in the context of a scenario. During the course of the test suite run, the high priority test cases execute first in order to improve the speed of error tracking.

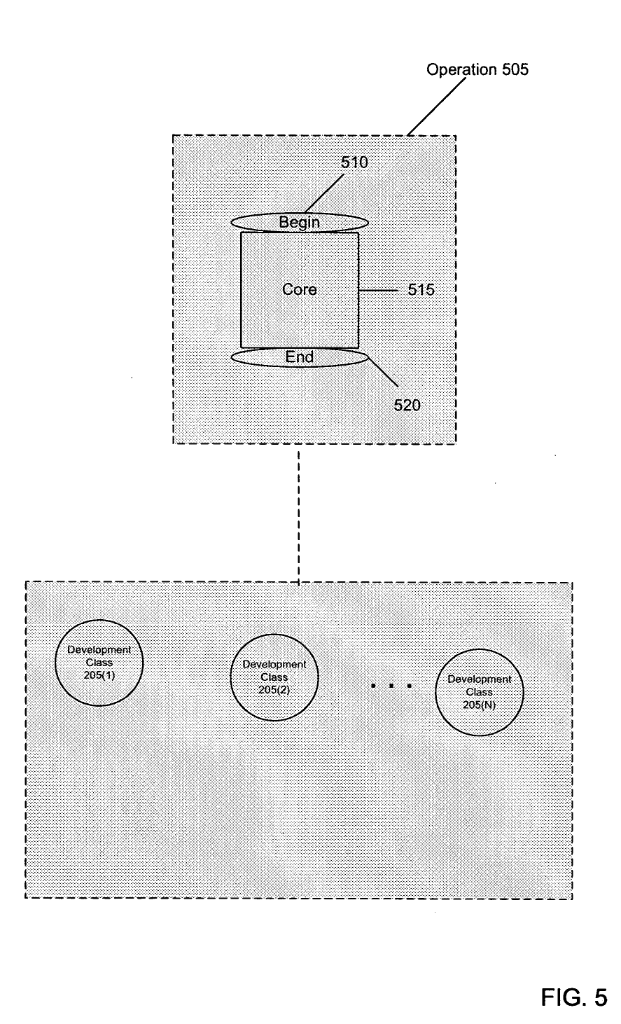

FIG. 5 depicts the structure of an operation according to one embodiment of the present invention. As shown in FIG. 5, each operation 505 includes begin element 510, end element 520 and core element 515. As shown in FIG. 5, each operation may include the collaborative behavior one or more development classes 205(1)-205(N).

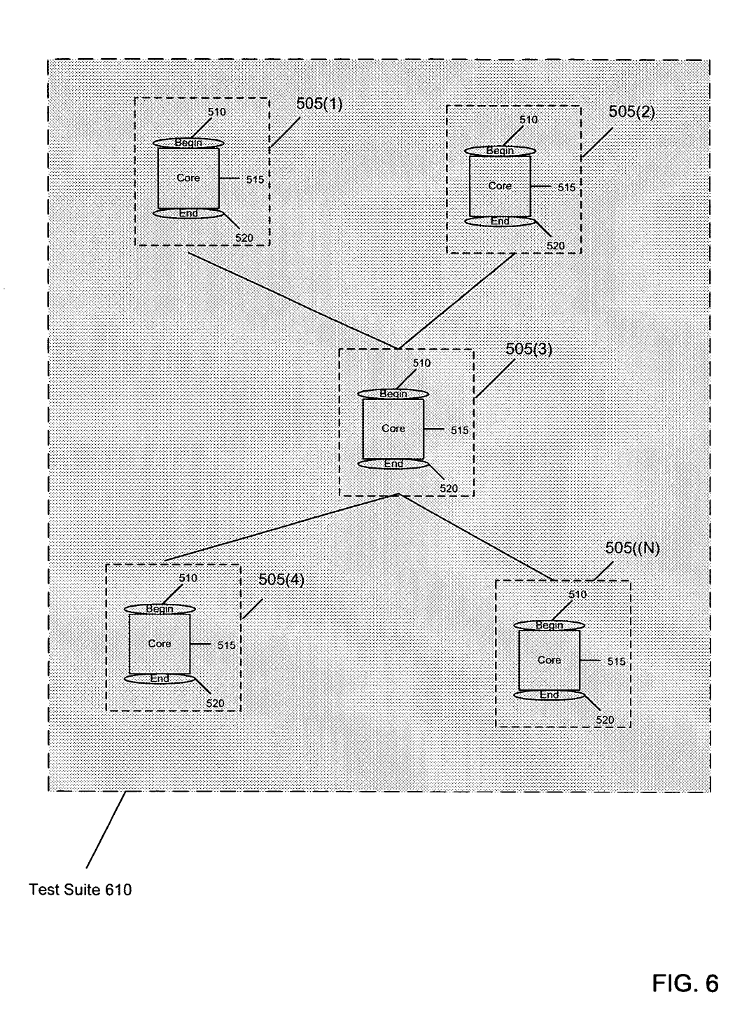

FIG. 6 shows the structure of a test suite according to one embodiment of the present invention. As shown in FIG. 6, test suite 610 involves a relationship between a plurality of operations 505(1)-505(N). According to one embodiment of the present invention, test suite 610 may define a relationship between operations 505(1)-505(N) in a hierarchical relationship.

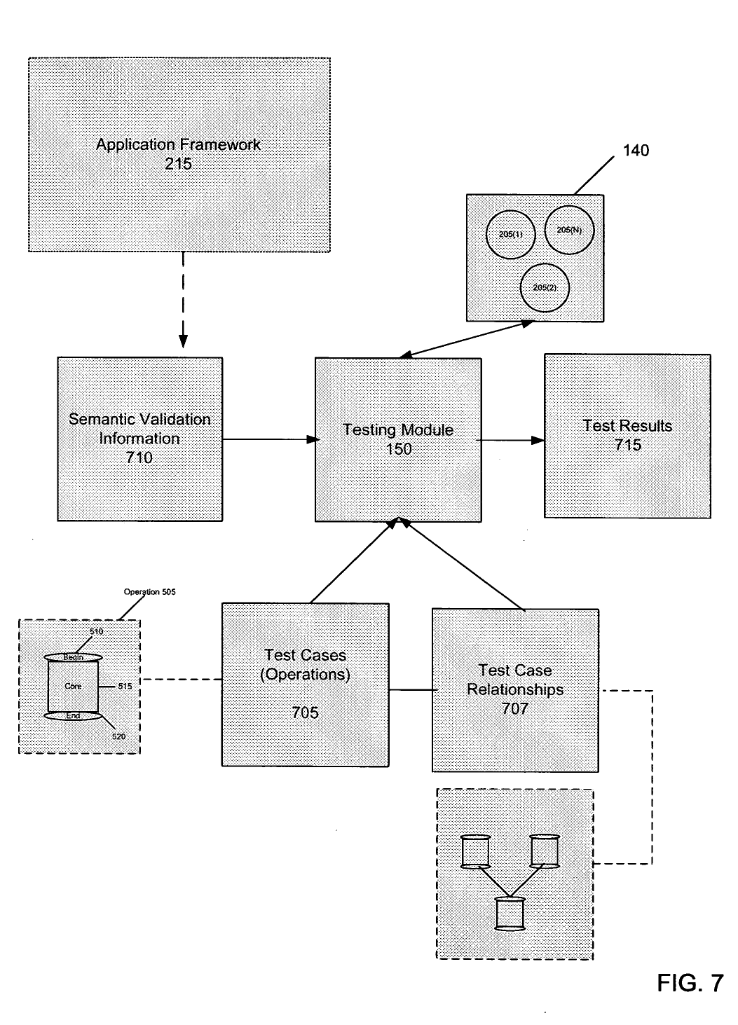

FIG. 7 depicts an operation of testing module 150 according to one embodiment of the present invention. Testing module 150 receives test case definitions 705. Each test case is associated with a particular operation 505. Testing module 150 further receives test case relationships 707, which define relationships between test cases 705. According to one embodiment of the present invention, test case relationships 707 may define a hierarchical relationship between test cases 505.

Testing module 150 also receives semantic validation information 710, which is derived from application framework 215. Testing module 150 then performs test of application 140, which includes development classes 205(1)-205(N) as a function of test case operations 705 and test case relationships 707. Testing module 150 then generates test results 715.

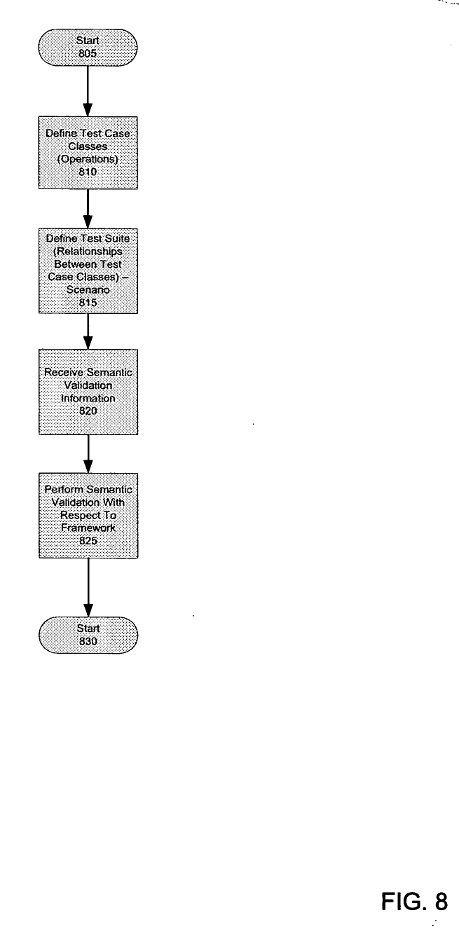

FIG. 8 is a flowchart depicting the operation of testing module 150 according to one embodiment of the present invention. The process is initiated in step 805. In step 810, test case classes are defined. In step 815, a test suite is defined. According to one embodiment, a test suite defines a relationship between a plurality of test case classes. In step 820, semantic validation information is received. According to one embodiment, as shown in FIG. 8, semantic validation information includes valid start states and probable end states. In step 825, the application is validated with respect to the semantics of the application framework. This is achieved as a function of the test cases, test suite and semantic validation information defined in steps 810, 815 and 820.

The following illustrates a portion of exemplary semantics for a single client environment relating to a framework referred to as application repository services. In order to define the object model, a fundamental set of dimensions is identified that the framework can handle. According to one embodiment of the present invention, the following dimensions are identified: (1) single client; (2) multiple clients; (3) multiple repositories.

(“ARS”).

| Semantics | Test Case | Operations |
|---|---|---|
| Initialization | Set Up | Create ARS |
| | | Root Instance |
| | | Options: Log on to the |
| | | Repository |
| | | User Management in |
| | | Force |
| | | User Management Not |
| | | in Force |
| | | Options: Data State |
| | | Cleaned |
| | | Retained |
| | Set Up Validation | |
| | Tear Down | Options: Reuse |
| | | Uninitialize + Free |
| | | Instance |
| | | Uninitialize + Recreate |
| | | New Instance |
| | | Refresh |
| | Tear Down Validation | |
| Repository | | |
| Administration: | | |
| User Management | | |
| Transaction | Set Up | Options: |
| | | Create Session |
| | | Share Session (for |
| | | Nested Transactions) |
| | | Options: Session Types |
| | | Buffered |
| | | Unbuffered |
| | | Both |
| | | Begin Transaction |
| | | Nesting Level Stored |
| Namespace | Set Up | Create Namespace |
| Management | | Own Repository |
| | | Another Repository |
| | Set Up Validation | |
| | Tear Down | Options: Close |
| | | Transaction |
| | | Commit (with nesting |
| | | level) |
| | | Rollback |
| | | Options: Reuse |
| | | Free the Session Object |
| | | Hold the session object |
| | Tear Down Validation | |
| Change Management | Set Up | Options: Changelist Type |
| | | Normal |
| | | Ownership Transfer |
| | | Options: Changelist Use |
| | | Create Changelist |
| | | Use Supplied |
| | | Changelist |
| | | Activate Changelist |
| | Set Up Validation | |
| | Tear Down | Options: Reuse |
| | | Release Changelist |
| | | Deactivate Changelist |
| | | Revert Changelist |
| | Tear Down Validation | |
| Repository | Set Up | Options: Create |
| Object Creator | | Single Object |
| | | Object Hierarchy |
| | | All Model Objects |
| | Set Up Validation | |
| | Tear Down | |
| | Tear Down Validation | |
| Repository Object | Set Up | |
| Destroyer | | |
| | Set Up Validation | |
| | Tear Down | |
| | Tear Down Validation | |

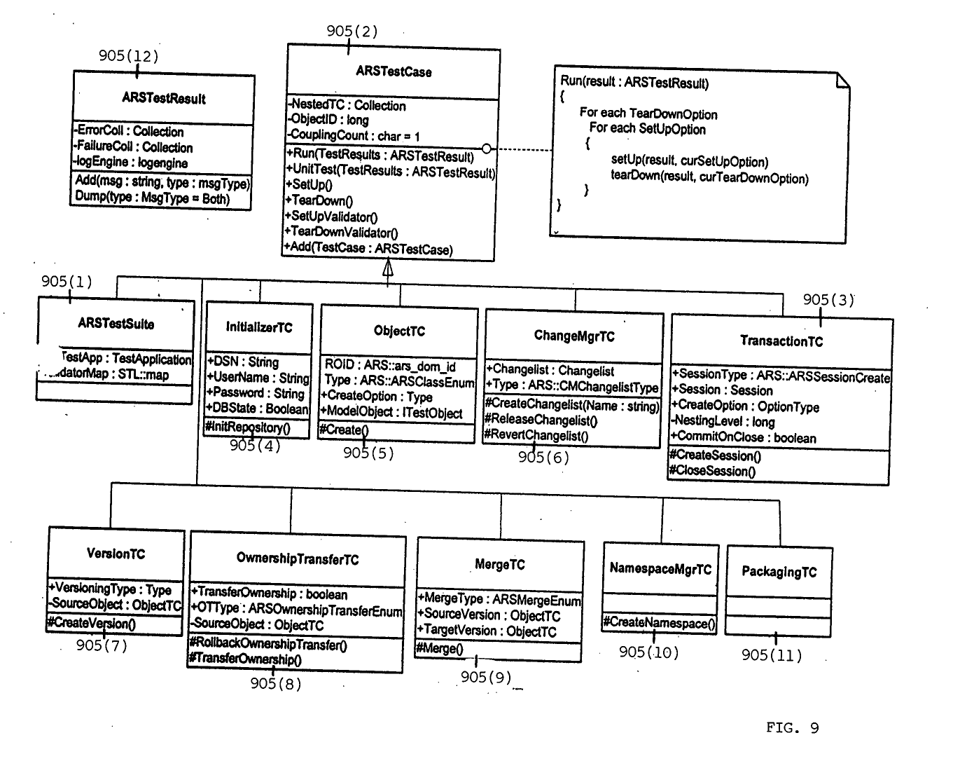

FIG. 9 depicts a structure of a test framework object model according to one embodiment of the present invention. In particular, FIG. 9 shows a set of test case classes constructed for identified semantics in each dimension. In particular, FIG. 9 shows test case classes ARSTest Suite 905(1), InitializerTC 905(4), ObjectTC 905(5), ChangeMgrTC 905(6), TransactionTC 905(3), VersionTC 905(7), OwnershipTransferTC 905(8), MergeTC 905(9), NamespaceMgrTC 905(10) and PackagingTC 905(11). Note that these test case classes correspond to the semantic dimensions identified above.

ARSTestResult class 905(12) is a helper class that contains all the errors that have occurred during testing. This class helps in generating a break-up of the error/failures during each stage of the test so that errors and failures can be reported separately. This information may be utilized to determine whether the TestSuite should continue or not.

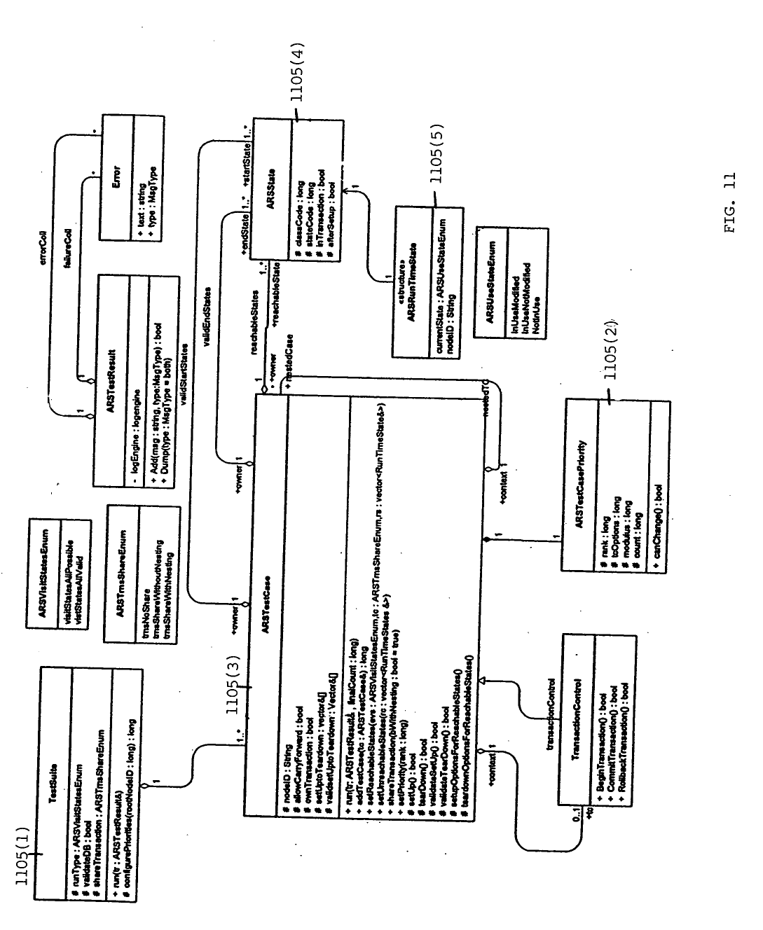

ARSTestCase class 905(2) is the base of all framework test case classes. This defines the basic set of operations that are allowed by the framework. Every instance of this class includes a unique identifier, which is used to determine the number of times that a particular instance has been added to the ARSTestSuite 905(1). As shown in FIG. 11, ARSTestCase 905(2) includes Setup and TearDown operations, which perform, respectively, initialization and finalization of the test case. For example, with respect to a particular test case class such as ChangeMgrTC 1005(6), initialization includes creation of the Changelist in ChangeMgrTC 905(6). Similarly, finalization relates to the ReleaseChangelisto in ChangeMgrTC 905(6). The SetUpValidatorMethod in ARSTestCase 905(2) ensures that all the required properties for the test case have been given. The UnitTest method is called when the user desires to perform the test for a specified set of options, which are set beforehand. The Run method allows the test case to explore all permutations of the test cases.

In order for the SetUp and TearDown operations to occur across the Testcase scopes (e.g., creation and release of a change list in two different transactions), the CouplingCount member variable is utilized. In these cases, the CouplingCount is set to 2 for the ChangeMgrTC 905(6) indicating that this instance of ChangeMgrTC will be added twice to the ARSTestSuite. This validation is performed during the Add process itself. Every time a nested test case is added to a test suite, its CouplingCount is checked. If the CouplingCount is greater than 1, then the unique identifier associated with the test case together with the CouplingCount value will be added to the ValidatorMap. If the unique identifier already exists, then CouplingCount is decremented by 1.

ARSTestSuite class 905(1) allows the grouping of a set of operations that must be run as a batch.

FIG. 11 depicts a test framework object model according to one embodiment of the present invention. As shown in FIG. 9, ARSTestSuite class 1105(1) is the base of all framework testcase classes, which defines basic operations that are allowed by the application framework. According on one embodiment, each instance of this class includes a unique identifier to determine the number of times that a particular instance has been added to an ARSTestSuite 1105(1).

The function run is called to run a particular test suite. For each test case aggregated by a particular test suite, this function calls the function validatePriorities for that test case. This function validates the ranks given to each node. The input to this function is a structure, which has all nodeID's and the ranks corresponding to these.

For each test case, the test suite aggregates, the run function calls the function configurePriorities for that test case. The function configurePriorities receives a toplevel testcase as its input and sets the relevant field present in the class ARSTestCasePriority 1105(2) associated with each test case in the tree. This function returns a long value corresponding to the total number of times the tree must be navigated to explore all possible options.

The ARSTestCase class 1105(3) is the base class from which all the other dimensional testcase classes are derived. The function setReachableStates navigates the subtree routed at itself and computes the Setup and TearDown Options based upon what states are requested to be visited. The input to this function is a vector of references to RunTimestates.

According to the present invention, the ARSTestCase class 1105(3) has eliminated the TransactionTC. Instead, according to the present invention, transaction control is incorporated in each dimensionalTC. This change allows removal of coupling semantics due to the TransactionTC (e.g., the need to release a changelist in an unbuffered session requires that the changemanagerTC be coupled with two TransactionTC's).

The function setUnreachableStates navigates the subtree routed at itself and modifies the Setup and TearDown Options based on what states are not required to be visited once all reachable states are set.

These two functions amount to two iterations through the RunTimeStates vector and the setup and teardown options, which is required in order to avoid exploring unnecessary setup and teardown operations.

The function setPriority allows setting the priority for the test case. According to one embodiment, the rank is an integer value, which determines where it stands relative to other test cases in the tree.

The functions setupOptionsForReachableStates and teardownOptionsForReachableStates allow setup of the setup and teardown options.

The function setupValidator is utilized to set node Ids of the nodes. In addition, setupValidator is used to obtain rank information from each node in a structure, which will have the nodeID and the corresponding rank.

The class ARSState 1105(4) maintains static information associated with a state. All possible start and end states of the dimensional TCs will be represented in the form of states. The dimensionalTC's hold references to these states in any of the categories of ValidStartStates, ValidEndStates and ReachableStates.

The class ARSRunTimeState 1105(5) maintains runtime information associated with a state. This class includes a reference to the associated state and additional information. The additional information identifies the node with which the ARSRunTimeState is associated and also provides present use status of the ARSRunTimeState. According to one embodiment, the use status will include one of the following: InUseNotModified, InUseModified and NotInUse. According to one embodiment, these three use states are stored in an enumeration called ARSUseStateEnum.

The class ARSTestCasePriority 1105(2) handles prioritization of the various test cases present in the tree structure.

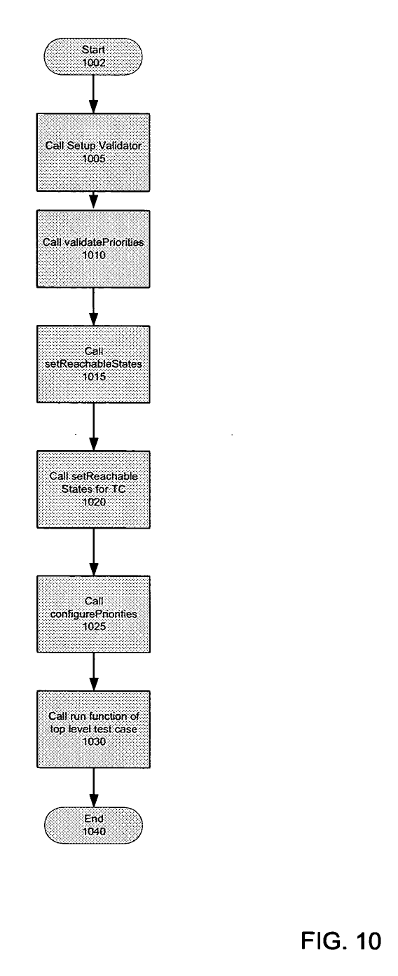

FIG. 10 is a flowchart depicting basic control flow of the testing module according to one embodiment of the present invention. In step 1005 SetupValidator is called on each of the inner test cases (nested TC's). This is to check if the necessary properties are set. If any property is not set, an error is logged and severity of the error is set. If the severity is critical, the Run is terminated. In addition, the nodeID for each of the test cases is set here, the rank information gathered and placed in a structured passed as a parameter to the function with the corresponding nodeID.

In step 1010, validatePriorites is called, which checks to determine whether the ranks that the inner testcases have been given are valid or not. If they are not valid, an error is logged and the severity of the error is set to critical, indicating that the run will be terminated.

In step 1015, setReachableStates for the test case is called. After placing the proper entries in the RunTimeStates vector, the TC will call setReachableStates for all of its children recursively so that the full tree structure is navigated. The value of tcoptions in the ARSTestCasePriority will also be appropriately changed.

In step 1020, setUnreachableStates for the TC is called. Based upon the currentState in the ARSRunTimeState entries not required will be removed and so will the corresponding setup/teardown options. TC will call setUnreachableStates for all of its children recursively so that the full tree structure is navigated. The value of tcOptions in the ARSTestCasePriority is then appropriately changed.

In step 1025, configurePriorities for the TC is called. Required attributes of the class ARSTestCasePriority of each DimensionalTC will be read. Based on these attributes, the other attributes will be set.

In step 1030, based upon the value returned by the function configurePriorities, a for loop is run in which the run function of the top level test case is called. The run function first calls canchange to see if the setup/teardown options need to be changed. The appropriate changes are made when required. Then the setup is called with performs the necessary setup based upon the current options. Then the run function for each of the child TC's is called (in this case ChangemanagerTC). Similarly the inner TC's are run. When the control comes from a child TC back to the parent after all child TC's are run, the teardown is called and the function returns to the calling function.

SetUpValidation performs initial validation. It performs check on the validity of the test cases that have been added as part of the current test suite. Initially the test suite validates the ValidatorMap. If there are any entries with non-zero values than an error for each of these objects is logged. The validation then proceeds to validate the properties that have been set (e.g., for the InitializerTC). If any such errors are logged, than the ARSTestResults instance is set a status as critical so that the testing is terminated with the log being dumped.

ValidatePriorites validates the ranks of various testcases in a particular tree. It checks for the following conditions: none of the ranks should be less than or equal to zero; the ranks should have values between 1 and the total number of test cases in the tree; no two test cases should have the same rank.

The process ends in step 1040.

A method and system for software testing that operates at the level of operations has been described. In order to achieve this, according to one embodiment, a test case class is defined for each operation.

1. A method for testing a software application comprising:
associating a test case class with each of a plurality of operations;
receiving a test scenario, the test scenario including at least one selected test case class;
receiving ranking information for the test scenario, the ranking information pertaining to relative prioritization of execution of each of the selected test case classes;
performing a test of the test scenario as a function of the ranking information.

2. The method according to claim 1, wherein each operation includes a collaborative behavior of a plurality of classes.

3. The method according to claim 1, wherein the ranking information is validated to be semantically correct with respect to a framework semantics.

4. The method according to claim 3, wherein the ranking information is validated to be semantically correct by defining valid start states and probable end states for each associated operation.

5. The method according to claim 3, wherein the ranking information is validated to be semantically correct with respect to a framework semantics by providing an editor that allows only valid nesting of test cases.

6. A system for testing a software application, comprising:
a storage device, the storage device storing a plurality of test case classes;
a processor, wherein the processor is adapted to:
associate a test case class with each of a plurality of operations;
receive a test scenario, the test scenario including at least one selected test case class;
receive ranking information for the test scenario, the ranking information pertaining to relative prioritization execution of each of the selected test case classes;
perform a test of the test scenario as a finction ranking information.

7. The method according to claim 6, wherein each operation includes a collaborative behavior of a plurality of classes.

8. The method according to claim 6, wherein the ranking information is validated to be semantically correct with respect to a framework semantics.

9. The method according to claim 8, wherein the ranking information is validated to be semantically correct by defining valid start states and probable end states for each associated operation.

10. The method according to claim 8, wherein the ranking information is validated to be semantically correct with respect to a framework semantics by providing an editor that allows only valid nesting of test cases.

11. A program storage device, the program storage device including instructions for:
associating a test case class with each of a plurality of operations;
receiving a test scenario, the test scenario including at least one selected test case class;
receiving ranking information for the test scenario, the ranking information pertaining to relative prioritization execution of each of the selected test case classes;
performing a test of the test scenario as a function ranking information.

12. The program storage device according to claim 11, wherein each operation includes a collaborative behavior of a plurality of classes.

13. The program storage device according to claim 11, wherein the ranking information is validated to be semantically correct with respect to a framework semantics.

14. The program storage device according to claim 13, wherein the ranking information is validated to be semantically correct by defining valid start states and probable end states for each associated operation.

15. The program storage device according to claim 13, wherein the ranking information is validated to be semantically correct with respect to a framework semantics by providing an editor that allows only valid nesting of test cases.

16. A system for testing a software application comprising:
a test module, the test module:
defining at least one test case class for each of a plurality of operations, wherein the operation is characterized as having a beginning and an end;
receiving first information describing valid start states and probable end states for each test case class;
receiving second information for relating at least a portion of the test case classes to reflect a particular scenario for testing;
performing a test of the particular scenario as a function of the first information and second information.
